(19) United States
(12) Patent Application Publication
(10) Pub. No.: US 2014/0360324 A1
(43) Pub. Date: Dec. 11, 2014

(54) BAND SAW MACHINE AND CONTROL METHOD OF BAND SAW MACHINE

(71) Applicants: AMADA COMPANY, LIMITED, Kanagawa (JP); AMADA MACHINE TOOLS COMPANY, LTD., Kanagawa (JP)

(72) Inventors: Toru Tokiwa, Kanagawa (JP); Masataka Kitai, Kanagawa (JP)

(73) Assignees: AMADA MACHINE TOOLS COMPANY, LTD., Kanagawa (JP); AMADA COMPANY, LIMITED, Kanagawa (JP)

(21) Appl. No.: 14/362,268

(22) PCT Filed: Nov. 19, 2012
(86) PCT No.: PCT/JP2012/079895

§ 371 Date: Jun. 2, 2014

(30) Foreign Application Priority Data
Dec. 27, 2011 (JP) 2011-284938

(51) Int. Cl. B23D 55/04; B23D 53/04

(52) U.S. Cl. CPC B23D 55/04; B23D 53/04; B23D 55/043
USPC 83/23; 83/151

(57) ABSTRACT

A feed vise is configured to position a work material on a pass line. A band saw blade has zero twisting, and is configured to cut the work material into a length smaller than a diameter of a driving wheel. A product discharge vise has product discharge vise jaws. The product discharge vise jaws clamp the work material, and the band saw blade is configured to be lowered and cut the work material. After the cutting is completed, the product discharge vise is configured to discharge a product, which is obtained by cutting the work material, below the pass line, while the product discharge vise clamps the product.

### TECHNICAL FIELD

The present invention relates to a band saw machine that cuts a work material by using a band saw blade, and a control method of the band saw machine.

### BACKGROUND ART

Band saw machines are widely used, and cut a work material such as cylindrical metal by allowing a band saw blade, which is wound around a pair of wheels, to rotate and travel. In this type of band saw machine, a twisted part is provided by partially twisting the band saw blade, and a work material is cut by the saw blade, the tooth tips of which face the work material due to the twisted part. Thus, an opposite part, which opposes the twisted part of the rotating and travelling band saw blade through the wheels, does not hit the work material. This way, a cutting length of a work material is not limited, and a product longer than a diameter of a wheel is obtained. A work material cut by a band saw machine is herein referred to as a product.

Patent Literature 1 describes a band saw machine in which a pair of wheels is arranged so that surfaces of wheels are in an almost vertical direction, and the tooth tips of a band saw blade face downward by twisting the band saw blade by approximately 90 degrees.

### CITATION LIST

### Patent Literature

[PTL 1] Japanese Patent Application Publication No. 2009-248294

### SUMMARY OF INVENTION

### Technical Problem

Tensile stress and bending stress act on a band saw blade that is wound around a pair of wheels because the saw blade is strained between the wheels and in contact with curved surfaces of the outer peripheries of the wheels. In addition to tensile stress and bending stress, torsional stress acts on a band saw blade provided with a twisted part. When a band saw blade provided with a twisted part is rotated, the resultant force of tensile stress, bending stress, and torsional stress acts repeatedly. Then, due to metal fatigue caused by long-term use of the band saw blade, the body of the band saw blade could rupture. Rupture of the body becomes a significant problem especially for a diamond band saw blade and a super-hard band saw blade that require high-speed rotation. This is because a band saw blade has to be replaced when the body ruptures before the end of life of the tooth tips made of diamond or super-hard chip, which are more expensive than a bimetal band saw blade.

Although a cutting length of a work material is limited to a length shorter than a diameter of the wheel, it is considered to have a band saw machine in which a band saw blade is not twisted, a so-called band saw machine with zero twisting of a band saw blade. Without twisting of the band saw blade, it is possible to significantly reduce rupture of a body, thereby extending the life of the band saw blade. A band saw machine with zero twisting of a band saw blade is useful for a particular purpose that allows a short cutting length of a work material.

However, in a band saw machine with zero twisting of a band saw blade, a work material is moved forward and positioned for discharging a product and ready for the next cut only after the band saw blade is retracted from the work material after the work material is cut. Therefore, there has been a problem that tact time is lost in a product manufacturing cycle in which products are manufactured sequentially by cutting the work material.

In view of the above-mentioned problem, an object of the present invention is to provide a band saw machine that is able to reduce a loss of tact time in a product manufacturing cycle even though a band saw blade has zero twisting, and a control method of the band saw machine.

### Solution to Problem

In order to solve the above-mentioned conventional problem, according to a first aspect, there is provided a band saw machine comprising: a feed vise configured to position a work material on a pass line, the work material being carried in from an upstream side to a downstream side: a band saw blade, which is wound around a pair of wheels and rotates and travels without being twisted, configured to cut the work material, which is positioned by the feed vice, into a length smaller than a diameter of the wheels, by lowering from above the pass line; and a product discharge vise that has a vise jaw for clamping the work material, configured to, clamp the work material on a downstream side of a cutting position of the work material before the work material is completely cut by the band saw blade, continue clamping the work material after the cutting, be lowered while clamping a product obtained by cutting the work material, and discharge the product below the pass line.

It is preferred that the band saw machine stated above includes a product discharge frame having a slope that slopes down from the upstream side to the downstream side, wherein the product discharge vise clamping the product is configured to be discharged along the slope.

It is preferred that the band saw machine stated above includes a vertically moving mechanism configured to lower the product discharge vise clamping the product in a vertical direction; and a horizontally moving mechanism configured to move the product discharge vise, which is lowered by the vertically moving mechanism, in a horizontal direction to the downstream side.

In the band saw machine stated above, it is preferred that the product discharge vise includes a support stand that supports the work material from underneath.

In the band saw machine stated above, it is preferred that the band saw machine is configured so that an upper end part of the vise jaw does not interfere with the band saw blade when the product discharge vise is discharged in a state where the band saw blade is positioned at a downward end where cutting of the work material by the band saw blade is completed.

In the band saw machine stated above, it is preferred that the product discharge vise clamping the product is configured to be lowered at a timing when the upper end part of the product does not interfere with the band saw blade when the band saw blade is moved up and retracted from the pass line from a state where the band saw blade is positioned at the downward end at which cutting of the work material by the band saw blade is completed.

It is preferred that the band saw machine stated above includes a product collection apparatus configured to collect the product discharged by the product discharge vise.

In order to solve the above-mentioned conventional problem, according to a second aspect, there is provided a control method of a band saw machine, comprising: a positioning step of positioning a work material on a pass line, the work material being carried in from an upstream side to a downstream side; a cutting step of cutting the work material by lowering a band saw blade from above the pass line, which is wound around a pair of wheels and rotates and travels without being twisted, into a length smaller than a diameter of the wheels, the work material being positioned in the positioning step; a clamping step of clamping the work material on a downstream side of a cutting position by a product discharge vise that clamps the work material, before cutting of the work material in the cutting step is completed; and a discharge step of discharging a product, which is obtained by cutting the work material in the cutting step, below the pass line, while the product discharge vise clamps the product.

In the above-mentioned control method of a band saw machine, it is preferred that, in the discharge step, the product discharge vise clamping the product is discharged along a slope that slopes down from the upstream side to the downstream side.

In the above-mentioned control method of a band saw machine, it is preferred that the discharge step includes: a vertical moving step of lowering the product discharge vise clamping the product in a vertical direction; and a horizontal moving step of moving the product discharge vise, which is lowered in the vertical moving step, in a horizontal direction to the downstream side.

In the above-mentioned control method of a band saw machine, it is preferred that the positioning step, the cutting step, the clamping step, the discharge step, and the product collection step are sequentially repeated, and the control method further comprises a returning step of returning the product discharge vise, after the product is collected in the product collection step, to a position for clamping the work material, which is positioned in a following positioning step, before cutting of the work material in a following cutting step is completed, in order that the product discharge vise clamps the work material in a following clamping step.

In the above-mentioned control method of a band saw machine, it is preferred that, in the returning step, a support stand included in the product discharge vise supports the work material from underneath.

In the above-mentioned control method of a band saw machine, it is preferred that the control method further includes a retraction step of retracting the band saw blade above the pass line after cutting of the work material in the cutting step is completed, wherein, in the discharge step, the product discharge vise clamping the product is lowered at a timing when an upper end part of the product does not interfere with the band saw blade when retracting the band saw blade in the retraction step.

It is preferred that the above-mentioned control method of a band saw machine, further includes a retraction preparation step of moving the work material to the upstream side by the feed vise prior to the retraction step, and moving the product to the downstream side by the product discharge vise.

It is preferred that the above-mentioned control method of a band saw machine, further includes a product collection step of collecting the product discharged in the discharge step.

### Effects of Invention

According to the band saw machine and the control method of the band saw machine, it is possible to reduce a loss of tact time in a product manufacturing cycle even though the band saw blade has zero twisting.

### BRIEF DESCRIPTION OF DRAWINGS

FIG. 1 is a side view according to a first embodiment, showing a state where a work material is cut.

FIG. 2 is a partial plan view showing a positional relation between the work material, and a driving wheel and a driven wheel that cause a band saw blade to rotate and travel according to each embodiment.

FIG. 3 is a block diagram showing a functional structure for operating each part according to the first embodiment.

FIG. 4 is a side view according to the first embodiment, showing a state where cutting of the work material is completed.

FIG. 5 is a side view according to the first embodiment, showing a state where a product is discharged.

FIG. 6 is partial side view according to the first embodiment, explaining a relation between a position of the band saw blade in the vertical direction and timing to discharge the product.

FIG. 7 is a side view according to the first embodiment, showing a state where a product discharge vise is returned and the repositioned work material is cut.

FIG. 8 is a side view showing a modified example of the first embodiment.

FIG. 9 is a view for explaining effects of the first embodiment.

FIG. 10 is a side view according to a second embodiment, showing a state before a work material is cut.

FIG. 11 is a block diagram showing a functional structure for operating each part according to the second embodiment.

FIG. 12 is a side view according to the second embodiment, showing a state where cutting of the work material is completed.

FIG. 13 is a side view according to the second embodiment, showing a state where a product discharge vise is moved in the vertical direction.

FIG. 14 is a side view according to the second embodiment, showing a state where the product discharge vise is moved in the horizontal direction.

FIG. 15 is a side view according to the second embodiment, showing a state where the product discharge vise is returned and the repositioned work material is cut.

FIG. 16 is a side view according to a third embodiment, showing a state before a work material is cut, and a state where cutting of the work material is completed.

FIG. 17 is a side view according to the third embodiment, showing a state where a product discharge vise is moved in a vertical direction and in a horizontal direction.

### DESCRIPTION OF EMBODIMENTS

A band saw machine and a control method of the band saw machine according to each embodiment are explained below with reference to the attached drawings.

### First Embodiment

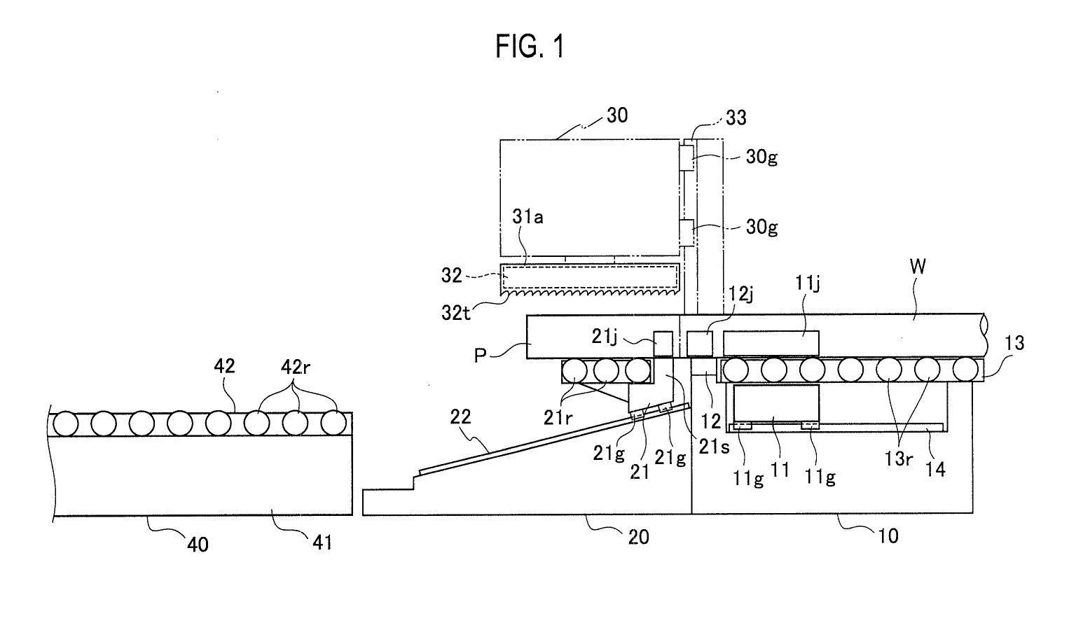

First of all, an overall structure of a band saw machine according to the first embodiment is explained. In FIG. 1, a body frame 10 includes a feed vise 11 for feeding a work material W to the left (in a downstream direction) in FIG. 1, a body vise 12 for fixing the work material W, and a free roller table 13. The feed vise 11 has feed vise jaws 11j for clamping the work material W, and guides 11g. The free roller table 13 has a plurality of rollers 13r. The guides 11g are engaged with a rail 14, and the feed vise 11 is able to move in a left-and-right direction along the rail 14. When the work material W is clamped by the feed vise jaws 11j and the feed vise 11 is moved in the left-and-right direction, the rollers 13r rotate and the work material W moves in the left-and-right direction.

The body vise 12 has body vise jaws 12j for clamping the work material W. The body vise 12 is arranged at a position immediately before a cutting position of the work material W, which is shown by an alternate long and short dash line, on an upstream side of the cutting position in a feed direction of the work material W.

In the body frame 10, a product discharge frame 20 is arranged on a downstream side in the feed direction of the work material W. The product discharge frame 20 includes a product discharge vise 21 for discharging a product P obtained by cutting the work material W. The product P is a distal end part side of the work material W from the cutting position shown by the alternate long and short dash line. The product discharge vise 21 has a support stand 21s for supporting the work material W from underneath, product discharge vise jaws 21j for clamping the work material W (the product P), guides 21g, and a plurality of rollers 21r. The rollers 21r are free rollers or driving rollers. In a state before the work material W is cut, the product discharge vise 21 is located immediately behind the cutting position on a downstream side of the cutting position.

As evident in FIG. 1, an upper surface of the product discharge frame 20 is a slope that slopes down from the right to the left in FIG. 1. A rail 22 is mounted on the slope. The guides 21g are engaged with the rail 22, and the product discharge vise 21 is able to move in the left-and-right direction along the rail 22. In other words, the product discharge vise 21 descends or ascends along the rail 22.

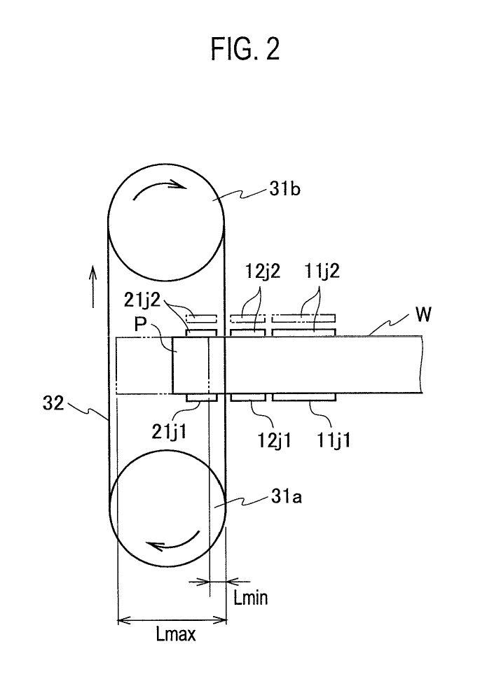

A saw blade housing 30 is arranged above the work material W. As shown in FIG. 2, the saw blade housing 30 includes a driving wheel 31a and a driven wheel 31b, and a band saw blade 32 that is wound around the driving wheel 31a and the driven wheel 31b. The band saw blade 32 is allowed to rotate and travel in an arrow direction by drive of the driving wheel 31a. FIG. 1 shows a side view of a band saw machine according to the first embodiment, in which the band saw machine is seen from the side with respect to the feed direction of the work material W, and the saw blade housing 30 and so on are partially shown by imaginary lines.

As shown in FIG. 1, the tooth tips 32t of the band saw blade 32 face the work material W. As seen in FIG. 1 and FIG. 2, the band saw blade 32 is not twisted, so has zero twisting. Guides 30g are engaged with a rail 33, and the saw blade housing 30 is able to move in an upper-and-lower direction along the rail 33. As the saw blade housing 30 is lowered while causing the band saw blade 32 to rotate and travel, the work material W is cut by the tooth tips 32t of the band saw blade 32 on a side traveling downwardly in FIG. 2.

In FIG. 2, a maximum length Lmax of a cutting length of the work material W is smaller than the diameters of the driving wheel 31a and the driven wheel 31b, and is a length obtained by deducting a slight margin from the lengths of the diameters. A minimum length Lmin of the cutting length of the work material W is, for example, a thickness of a product P that is able to stand on its own. Of course, the minimum length Lmin may be a thickness of a product P that is not able to stand on its own as long as a way to collect the product P is devised. In this case, it is possible to reduce the minimum length Lmin to the limit.

As shown in FIG. 2, the feed vise jaws 11j, the body vise jaws 12j, the product discharge vise jaws 21j are made of fixed vise jaws 11j1, 12j1, 21j1, and movable vise jaws 11j2, 12j2, 21j2, respectively. The fixed vise jaws 11j1, 12j1, 21j1 are fixed in place, and the movable vise jaws 11j2, 12j2, 21j2 move from positions shown by broken lines when clamping the work material W, and hold the work material W.

A product collection apparatus 40 is arranged on a downstream side of the product discharge frame 20. The product collection apparatus 40 shown in FIG. 1 is, for example, made of a product collection conveyor 42 arranged on a frame 41. The product collection conveyor 42 has a plurality of rollers 42r. The plurality of rollers 42r is driven by a driving part that is not shown. Alternatively, instead of driving the product collection conveyor 42, the product collection conveyor 42 may be inclined so that the product descends from the right to the left in FIG. 1 due to the weight of the product itself.

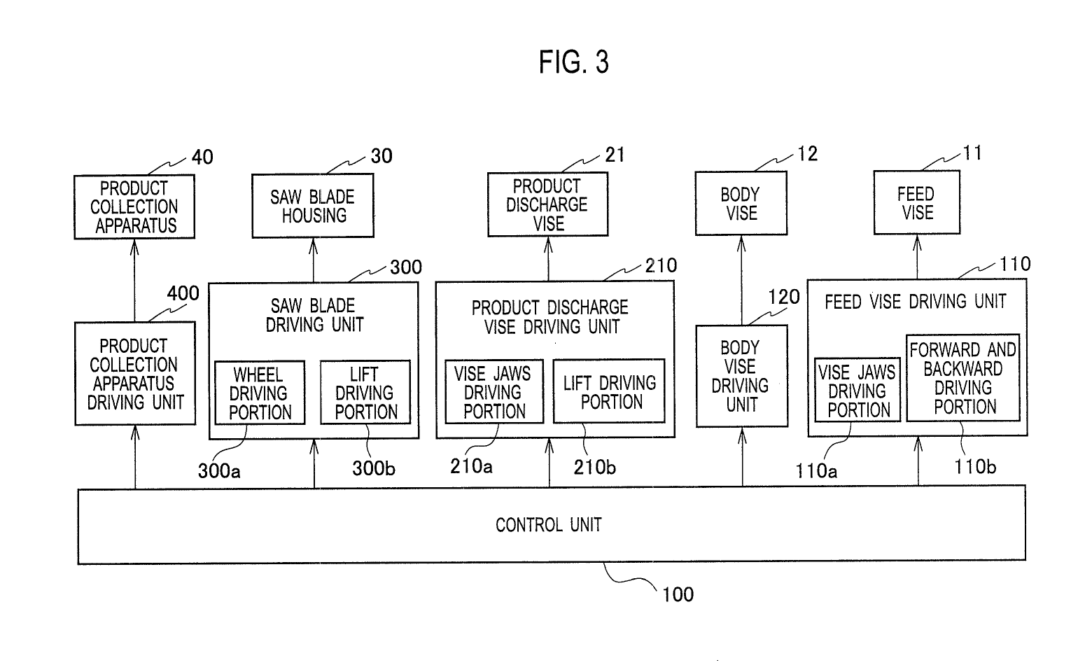

A functional structure for operating each part of the band saw machine according to the first embodiment is explained by using FIG. 3. In FIG. 3, the feed vise 11 is driven by a feed vise driving unit 110 provided in the body frame 10. The feed vise driving unit 110 includes a vise jaws driving portion 110a that drives the feed vise jaws 11j to clamp or unclamp the work material W, and a forward and backward driving portion 110b that allows the feed vise 11 to move forward and backward. The body vise 12 is driven by a body vise driving unit 120 provided inside the body frame 10. The body vise driving unit 120 drives the body vise jaws 12j so as to clamp or unclamp the work material W.

The product discharge vise 21 is driven by a product discharge vise driving unit 210 provided inside the product discharge frame 20. The product discharge vise driving unit 210 includes a vise jaws driving portion 210a that drives the product discharge vise jaws 21j to clamp and unclamp the work material W, and a lift driving portion 210b that lifts and lowers the product discharge vise 21. The saw blade housing 30 is driven by a saw blade driving unit 300 provided inside the saw blade housing 30. The saw blade driving unit 300 includes a wheel driving portion 300a that drives the driving wheel 31a to cause the band saw blade 32 to rotate and travel, and a lift driving portion 300b that lifts and lowers the saw blade housing 30.

The product collection apparatus 40 is driven by a product collection apparatus driving unit 400 provided inside the product collection apparatus 40. In a case where the product collection apparatus 40 includes the product collection conveyor 42, the product collection apparatus driving unit 400 drives and rotates the rollers 42r of the product collection conveyor 42.

The feed vise driving unit 110, the body vise driving unit 120, the product discharge vise driving unit 210, the saw blade driving unit 300, and the product collection apparatus driving unit 400 are controlled by a control unit 100. The control unit 100 only needs to be provided at an arbitrary position. The control unit 100 is structured by, for example, a microcomputer. The microcomputer includes a storage unit where a control program for controlling an operation of each of the driving units, and a microprocessor for executing the control program to control each of the driving parts. The control unit 100 may also be structured by a plurality of microcomputers.

Next, steps of a control method carried out in the band saw machine according to the first embodiment are explained. The steps (processes) explained below are carried out by the respective driving units based on control by the control unit 100. In other words, the control program provided in the control unit 100 causes a computer installed in the band saw machine to execute the respective processes described below.

### (Process A: Positioning Process of a Work Material W)

When a work material W is carried into the body frame 10 by a non-illustrated conveyance mechanism from the upstream side to the downstream side, the feed vise 11 clamps the work material W by using the feed vise jaws 11j, and moves the work material W forward to a position corresponding to a length of a product P after cutting. At this time, the body vise jaws 12j and the product discharge vise jaws 21j are in an unclamped state. Once a distal end part the work material W, which corresponds to the length of the product P, projects from the cutting position, the body vise 12 clamps the work material W by using the body vise jaws 12j, and the product discharge vise 21 then clamps the work material W by using the product discharge vise jaws 21j.

At this time, it is preferred that the product discharge vise jaws 21j clamp the work material W in a state where the product discharge vise 21 is lifted from a position where the product discharge vise 21 is lowered slightly from the state shown in FIG. 1 so that the support stand 21s abuts on the work material W from beneath. FIG. 1 shows a state where the work material W is positioned as stated above and clamped by the feed vise jaws 11j, the body vise jaws 12j, and the product discharge vise jaws 21j.

### (Process B: Cutting Process of the Work Material W)

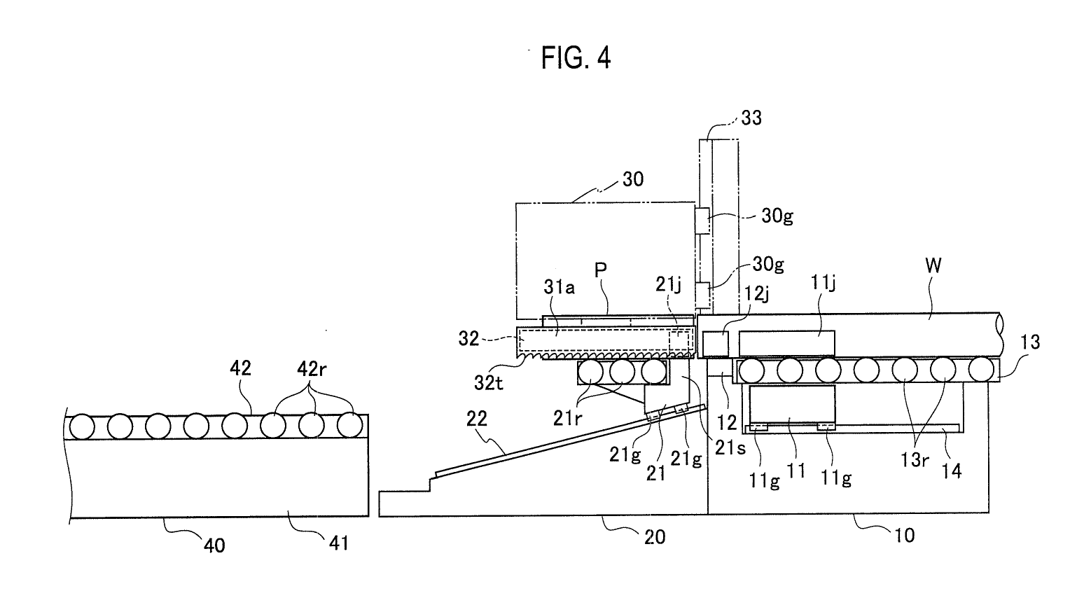

The saw blade housing 30 is lowered while causing the band saw blade 32 to rotate and travel. Thus, the band saw blade 32 is lowered from above and towards a pass line on which the work material W is conveyed. Once the tooth tips 32t of the band saw blade 32 reach a lower end of the work material W, cutting of the work material W is completed. FIG. 4 shows a state where cutting of the work material W is completed. As stated earlier, the work material W is cut into a length that is shorter than the diameters of the driving wheel 31a and the driven wheel 31b.

### (Process C: Retraction Preparation Process of the Band Saw Blade 32)

After cutting of the work material W is completed, the body vise 12 unclamps the work material W. The feed vise 11 slightly moves the work material W backward, and the product discharge vise 21 slightly moves the cut product P forward. Moving backward means a movement to the upstream side, and moving forward means a movement to the downstream side. In this embodiment, the product P is moved forward by slightly lowering the product discharge vise 21. Thus, the tooth tips 32t of the band saw blade 32 are separated from a distal end surface of the work material W after cutting and a back end surface of the product P, thereby preventing the tooth tips 32t from being damaged when retracting the band saw blade 32 upwardly.

### (Process D: Retraction Process of the Band Saw Blade 32 and Discharge Process of the Product P)

Next, the saw blade housing 30 is lifted to retract the band saw blade 32 above the pass line. After retraction of the band saw blade 32 is completed, the product discharge vise 21 is lowered while clamping the product P. It is herein stated that the product discharge vise 21 is lowered after retraction of the band saw blade 32 is completed. However, in the first embodiment, in some cases, lowering of the product discharge vise 21 is able to begin before retraction of the band saw blade 32 is completed as described later.

### (Process E: Collection Process of the Product P)

When the product discharge vise 21 is lowered to a downward end of the slope, the product discharge vise 21 unclamps the product P. The product collection apparatus 40 conveys and collects the product P by using the product collection conveyor 42.

### (Process F: Repositioning Process of the Work Material W)

When the band saw blade 32 is retracted from the pass line of the work material W to above, the feed vise 11 moves to the upstream side and clamps the work material W. Then, after it is confirmed that the body vise 12 has unclamped the work material W, the feed vise 11 moves the work material W forward for cutting of the work material W. Once the position of the work material W is determined, the body vise 12 clamps the work material W.

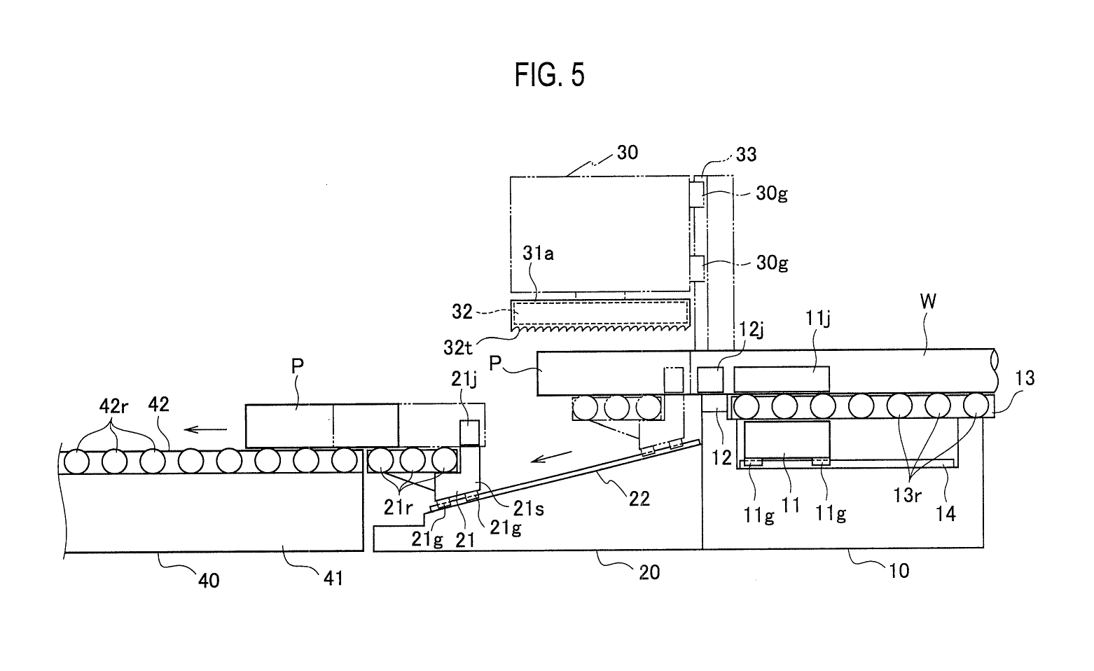

FIG. 5 shows a state where the product discharge vise 21 is lowered to the downward end of the slope, the product P is conveyed by the product collection conveyor 42, the band saw blade 32 is retracted from the pass line of the work material W to above, and the work material W is newly positioned. FIG. 5 is only an example of timing for the discharge and collection processes of the product P, and timing for the repositioning process of the work material W. The product P can be collected before new positioning of the work material W is completed, or the product P can be collected after the positioning is completed depending on various conditions such as a length of the product discharge frame 20, lowering speed of the product discharge vise 21, feeding speed of the work material W by the feed vise 11, and a length of the product P.

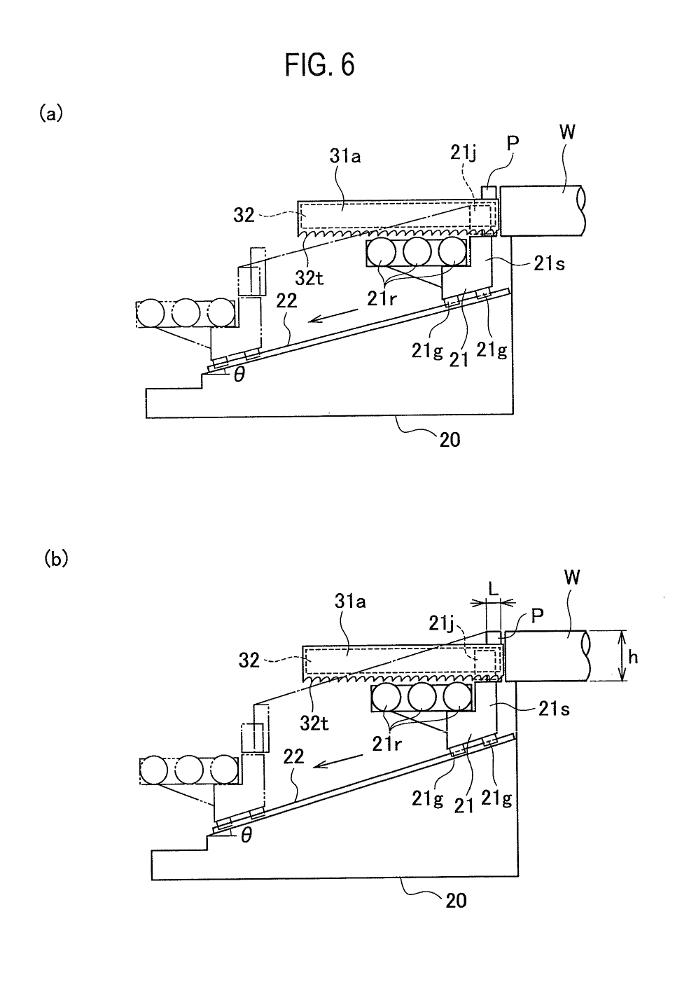

A relation between a position of the band saw blade 32 in the vertical direction, and timing to lower the product discharge vise 21 is explained by using FIG. 6. FIG. 6 only depicts the product discharge vise 21 that moves on the product discharge frame 20, the band saw blade 32, and the work material W (product P). FIG. 6 shows an example case where the product P is relatively short.

First of all, as shown in (a) of FIG. 6, it is preferred that the slope has an inclination angle θ by which upper end parts of the product discharge vise jaws 21j do not interfere with the band saw blade 32 when the product discharge vise 21 is moved from an upward end to the downward end in a state where the band saw blade 32 is positioned at a downward end. In a later-described returning process of the product discharge vise 21, the product discharge vise 21 moves from the downward end to the upward end and returns to an original position without clamping the product P. Even when the band saw blade is positioned at the downward end at that time, the inclination angle θ is set so as not to allow the upper end parts of the product discharge vise jaws 21j to interfere with the band saw blade 32.

Further, as shown in (b) of FIG. 6, it is preferred that the slope has the inclination angle θ by which an upper end part of the product P does not interfere with the band saw blade 32 when the product discharge vise 21 is moved from the upward end to the downward end in a state where the band saw blade 32 is positioned at the downward end. In a case of (b) of FIG. 6, it is possible to start lowering the product discharge vise 21 before retraction of the band saw blade 32 positioned at the downward end begins. Therefore, in the first embodiment, it is possible to start lowering the product discharge vise 21 before or simultaneously with the start of retraction of the band saw blade 32, depending on the length L of the product P.

Even though the upper end part of the product P interferes with the band saw blade 32 that is positioned at the downward end, it is possible to start lowering the product discharge vise 21 in a middle of retraction of the band saw blade 32 in a case where, after retraction of the band saw blade 32 is started, the upper end part of the product P ceases to interfere with the band saw blade 32 before the band saw blade 32 is separated from the upper end of the work material W. In the first embodiment, it is possible to start lowering the product discharge vise 21 before or simultaneously with start of retraction of the band saw blade 32, or, after retraction is started or before retraction is completed except in special cases where the length L of the product P is larger than a given length.

The control unit 100 is previously given the inclination angle θ, and positional information of the tooth tips 32t when the band saw blade 32 is positioned at the downward end, in particular, positional information of the tooth tips 32t on a downstream side in the feed direction of the work material W, which faces the tooth tips 32t on the side of cutting the work material W. A height h of the work material W and the length L of the product P are inputted to the control unit 100. Then, the control unit 100 is able to calculate and determine the timing to start lowering the product discharge vise 21 during retraction of the band saw blade 32. The control unit 100 may also store a table in advance, in which the timing to start lowering the product discharge vise 21 is set corresponding to the height h of the work material W and the length L of the product P, and obtain the timing from the table.

In a case where the upper end part of the product P stops interfering with the band saw blade 32 only after the band saw blade 32 is completely retracted, it is only necessary to lower the product discharge vise 21 after retraction of the band saw blade 32, which is a basic operation of the first embodiment, is completed. Also, in a case where the product discharge vise 21 can be lowered before retraction of the band saw blade 32 is completed, the product discharge vise 21 may be lowered after retraction of the band saw blade 32 is completed.

### (Process G: Returning Process of the Product Discharge Vise 21)

After the product P is conveyed by the product collection conveyor 42, the product discharge vise 21 is moved up to the upward end. The support stand 21s of the product discharge vise 21 abuts on the work material W from underneath to support the work material W. Then, the product discharge vise 21 clamps the work material W by using the product discharge vise jaws 21j. Thus, the product discharge vise 21 returns to the state shown in FIG. 1.

It is possible to begin the process H, which is the cutting process of the work material W described later, before the returning process of the product discharge vise 21 is completed. The work material W is repositioned in the foregoing process F, which is the repositioning process of the work material W, and the work material W is clamped by the feed vise 11 and the body vise 12. Then, the band saw blade 32 starts cutting the work material W before the product discharge vise 21 is returned. Since, in some cases, the support stand 21s abuts on the work material W during cutting of the work material W, it is preferred that the support stand 21s is a floating structure so as not to affect the machining process, in other words, so as to reduce force generated when the support stand 21s hits the work material W.

Since, in some cases, the product discharge vise jaws 21j clamp the work material W while the work material W is cut, it is preferred that the clamping force of the product discharge vise jaws 21j is smaller than the clamping force of the body vise jaws 12j. By reducing the clamping force of the product discharge vise jaws 21j to be smaller than the clamping force of the body vise jaws 12j, it is possible to eliminate a possibility that the work material W could move while being cut and the tooth tips 32t could be damaged. The product discharge vise 21 only needs to clamp the work material W with force that is just enough to lower the cut product P to the downward end and discharge the product P.

### (Process H: Cutting Process of the Work Material W)

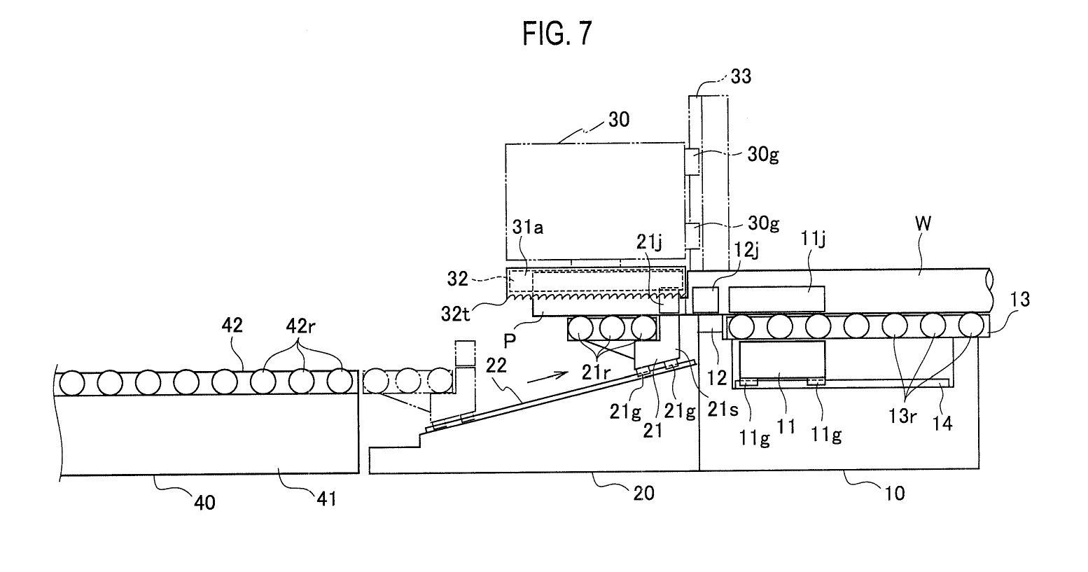

The saw blade housing 30 is lowered while the band saw blade 32 is caused to rotate and travel. FIG. 7 shows a state where the product discharge vise 21 is returned in the process G, which is the returning process of the product discharge vise 21, and the work material W is being cut by the band saw blade 32. Once the tooth tips 32t of the band saw blade 32 reach the lower end of the work material W, cutting of the work material W is completed. Once cutting of the work material W is completed, the foregoing processes C to H are repeated, and the product P is manufactured sequentially.

Before cutting of the work material W in the process H is completed, it is necessary to return the product discharge vise 21 and clamp the work material W (the product P) by using the product discharge vise jaws 21j. Therefore, in a case where cutting of the work material W is completed before the product discharge vise 21 is returned, it is only necessary to suspend cutting of the work material W (lowering of the saw blade housing 30) and restart the cutting after the product discharge vise 21 is returned. Alternatively, the product discharge vise 21 may clamp the product P before completion of machining, by making a prediction judgment of a critical path of time required until completion of machining and time required for the product discharge vise 21 to return during the machining, and adjusting machining speed.

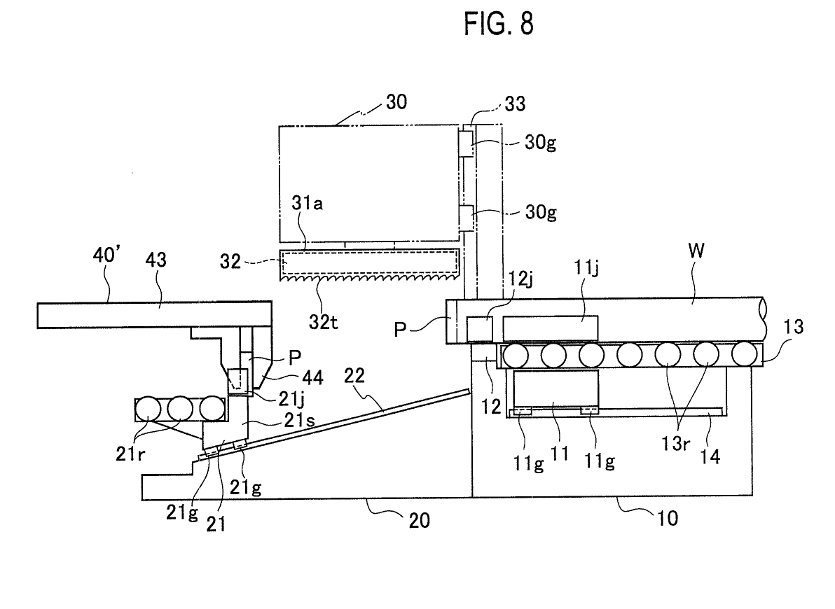

FIG. 8 shows a modified example in which a collection apparatus 40′ using a product collection arm 43 is used instead of the product collection apparatus 40 using the product collection conveyor 42. The product collection arm 43 is a so-called arm type robot. The product collection arm 43 has a collection vise 44. FIG. 8 shows an example case in which a product P is relatively short. The collection vise 44 clamps the product P in a thickness direction, and unclamps the product P at a predetermined position after moving the collection arm 43 so that the product P is collected. A method for collecting the product P may be arbitrarily decided.

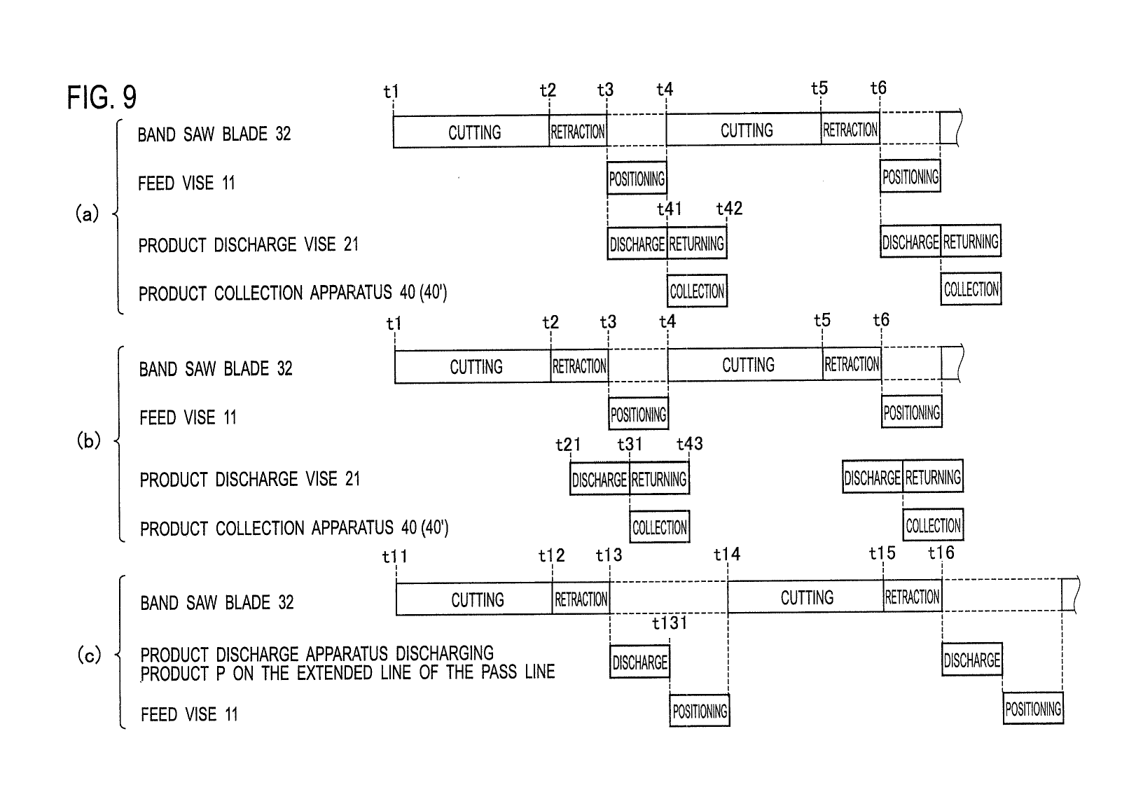

An effect of reducing a loss of tact time in the first embodiment is explained by using FIG. 9. (a) of FIG. 9 roughly shows the timing of respective operations including cutting of the work material W by the band saw blade 32, retraction of the band saw blade 32, positioning of the work material W by the feed vise 11, discharge of the product by the product discharge vise 21, returning of the product discharge vise 21, and collection of the product by the product collection apparatus 40 (40′), in a case where the product discharge vise 21 is lowered after retraction of the band saw blade 32 is completed.

The band saw blade 32 starts lowering at time t1 and completes cutting at time t2. Then, immediately, the band saw blade 32 prepares for retraction, starts retracting, and completes the retraction at time t3. Since it is possible to position the work material W once the retraction is completed, the feed vise 11 instantly starts the positioning operation for the work material W, and completes the positioning at time t4. The product discharge vise 21, which clamps the product P, starts lowering at time t3 when the retraction is completed, and reaches the downward end at time t41. Time t3 to time t41 corresponds to the discharge operation of the product P. Time t41 is before or after, or at the same time as time t4. In parallel with collection of the product P, the product discharge vise 21 starts moving up at time t41, and reaches the upward end and returns to the original position at time t42.

The band saw blade 32 starts to lower at time t4 when the positioning is completed, and completes cutting at time t5. The product discharge vise 21 clamps the work material W before cutting of the work material W is completed at time t5. Time t42 can be before or at the same time as time t4, and the product discharge vise 21 can clamp the work material W before cutting of the work material W is completed between time t4 and time t5. The band saw blade 32 completes the retraction at time t6, and repeats the same operation thereafter. After time t6, the feed vise 11, the product discharge vise 21, the product collection apparatus 40 (40′) also repeat the same operations.

As evident in (a) of FIG. 9, according to the first embodiment, the discharge and returning operations of the product discharge vise 21 are carried out in parallel with the operations of cutting the work material W by the band saw blade 32, retraction of the band saw blade 32, and positioning of the work material W by the feed vise 11. Thus, it is possible to substantially eliminate a loss of tact time.

(b) of FIG. 9 roughly shows timing of respective operations including cutting of the work material W by the band saw blade 32, retraction of the band saw blade 32, positioning of the work material W by the feed vise 11, discharge of the product by the product discharge vise 21, returning of the product discharge vise 21, and collection of the product by the product collection apparatus 40 (40′), in a case where the product discharge vise 21 is lowered before retraction of the band saw blade 32 is completed. The operations of cutting of the work material W by the band saw blade 32, retraction of the band saw blade 32, and positioning of the work material W by the feed vise 11 are the same as those shown in (a) of FIG. 9.

The product discharge vise 21 is able to start lowering once conditions are satisfied, under which the upper end part of the product P does not interfere with the band saw blade 32 when the product discharge vise 21 is lowered after cutting is completed at time t2. The product discharge vise 21 starts lowering at time t21 and reaches the downward end at time t31. Time t21 to time t31 corresponds to the discharge operation of the product P. As stated earlier, time t21 can coincide with time t2. The product collection apparatus 40 (40′) spends a given period of time from time t31 to collect the product P. In parallel with collection of the product P, the product discharge vise 21 starts moving up at time t31, reaches the upward end and returns to the original position at time t43.

When a diameter of the work material W is small, time required for cutting becomes short. Therefore, as stated earlier, in some cases, it is necessary to suspend cutting of the work material W and restart the cutting after the product discharge vise 21 is returned. In such a case, there is a small loss of tact time. In the case of (b) of FIG. 9, it is possible to advance timing to return the product discharge vise 21 to the original position. In the case of (b) FIG. 9, even when the cutting time is short, it is possible to reduce a loss of tact time, or even eliminate a loss of tact time in some cases.

As evident from (a) and (b) of FIG. 9, it is possible to substantially eliminate a loss of tact time according to the first embodiment.

For comparison, a case is explained by using (c) of FIG. 9, in which the product P is discharged by a given product discharge apparatus on an extended line of the pass line. The band saw blade 32 starts lowering at time t11, completes cutting at time t12, and completes retraction at time t13. In a case where the product P is discharged on the extended line of the pass line, the product P is able to be discharged only after retraction of the band saw blade 32. Further, positioning of the work material W for the next cutting is done only after the product P is discharged. The product discharge apparatus starts discharging the product P at time t13, and completes discharge of the product P at time t131. Although not illustrated in particular, the product P is collected after time t131.

The feed vise 11 starts the positioning operation at time t131, and completes the positioning at time t14. The band saw blade 32 starts lowering at time t14, completes cutting at time t15, and completes retraction at time t16. Thereafter, the band saw blade 32 repeats the same operation. After time t16, the product discharge apparatus and the feed vise 11 repeat the same operations. In the case of (c) of FIG. 9, there is a loss of tact time. According to the first embodiment, an effect is also obtained that a larger number of products P are manufactured in the same period of time.

### Second Embodiment

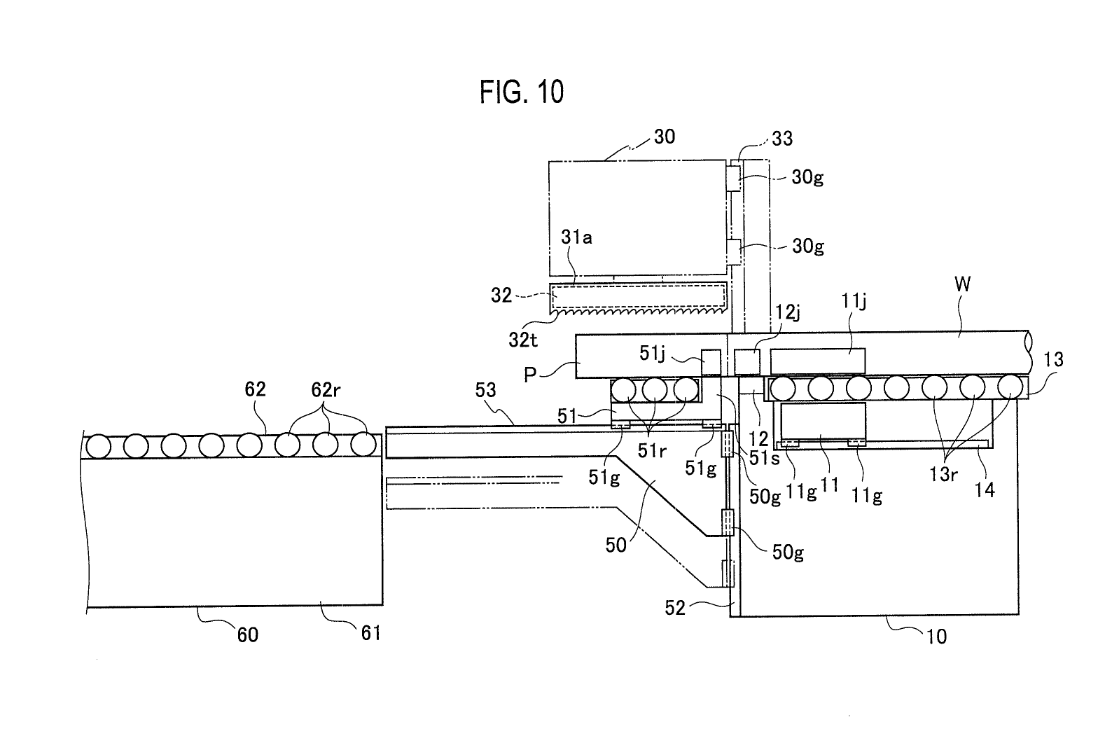

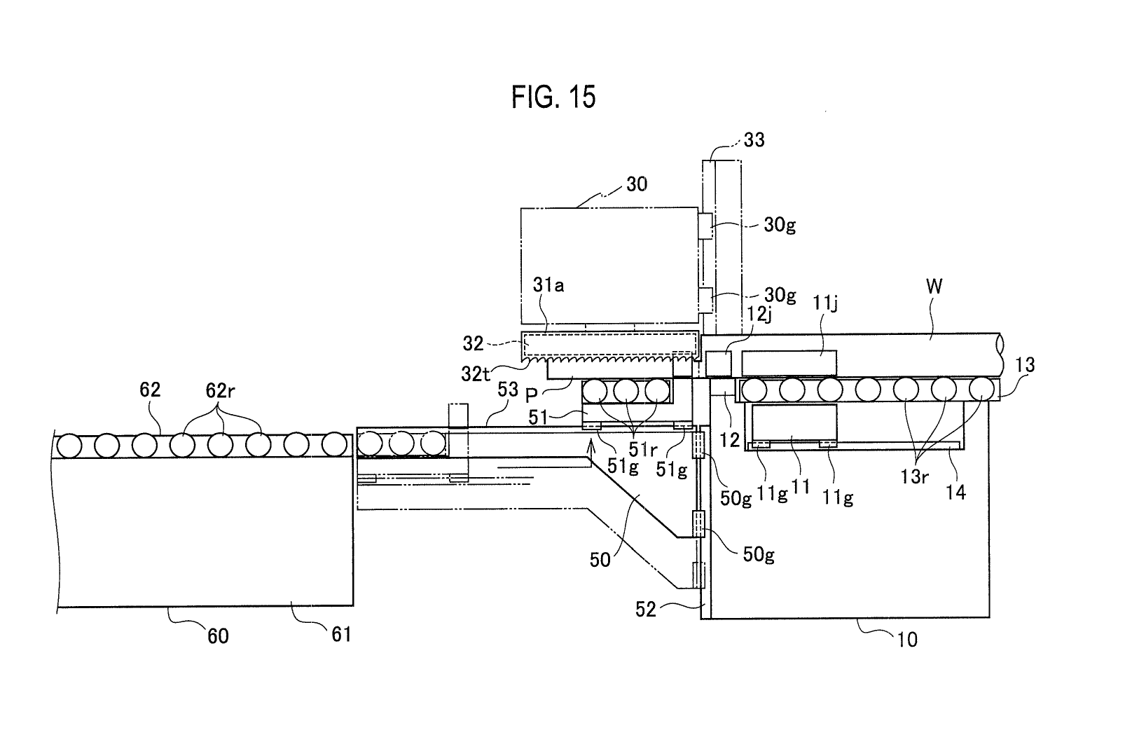

A second embodiment is explained by using FIG. 10 to FIG. 15. In FIG. 15, the same reference numerals are used for the same parts as those of the first embodiment explained in FIG. 1 to FIG. 9, and explanation thereof is omitted as necessary. In the second embodiment, a lifting apparatus 50 and a product discharge vise 51 are provided instead of the product discharge frame 20 and the product discharge vise 21 described in the first embodiment, and a product collection apparatus 60 is provided instead of the product collection apparatus 40.

The product discharge vise 51 is mounted on the lifting apparatus 50. Guides 50g are provided in an end part of the lifting apparatus 50 on a body frame 10 side. The guides 50g are engaged with a rail 52 extending in a vertical direction, and the lifting apparatus 50 is able to move in the vertical direction (an upper-and-lower direction) along the rail 52. Thus, the product discharge vise 51 moves in the vertical direction. A rail 53, extending in a horizontal direction, is attached on an upper surface of the lifting apparatus 50.

The product discharge vise 51 includes a support stand 51s that supports a work material W from underneath, product discharge vise jaws 51j for clamping the work material W (a product P), guides 51g, and a plurality of rollers 51r. The rollers Sir are free rollers or driving rollers. The guides 51g are engaged with the rail 53, and the product discharge vise 51 is able to move in the horizontal direction (a left-and-right direction) along the rail 53. As stated above, in the second embodiment, a vertically moving mechanism for lifting and lowering the product discharge vise 51 by using the lifting apparatus 50, and a horizontally moving mechanism for moving the product discharge vise 51 in the horizontal direction are provided. The product discharge vise 51 is able to move in the vertical direction and the horizontal direction independently from each other.

The product collection apparatus 60 is arranged on a downstream side of the lifting apparatus 50. The product collection apparatus 60 has a similar structure to that of the product collection apparatus 40, and is made of a product collection conveyor 62 arranged on a frame 61. The product collection conveyor 42 has a plurality of rollers 62r. The product collection apparatus 60 may have a structure using a product collection arm, similarly to the product collection apparatus 40′.

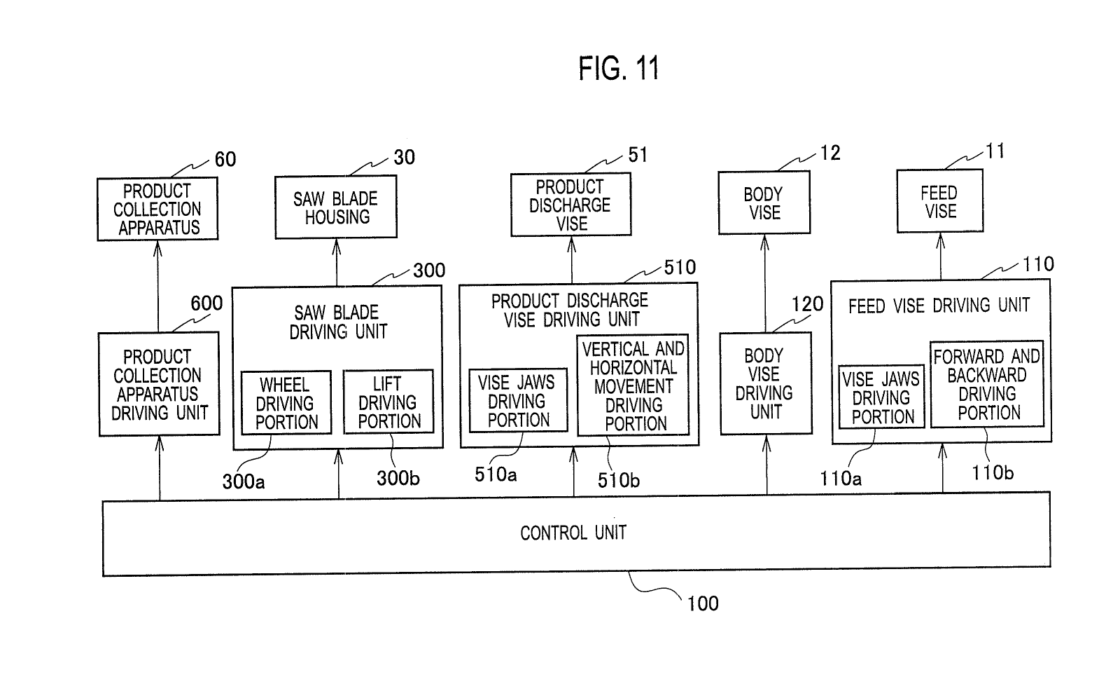

A functional structure of a band saw machine according to the second embodiment is as shown in FIG. 11. In FIG. 11, the product discharge vise 51 is driven by a product discharge vise driving unit 510 that is provided at a given position. The product discharge vise driving unit 510 includes a vise jaws driving portion 510a, which drives the product discharge vise jaws 51j to clamp or unclamp the work material W, and a vertical and horizontal movement driving portion 510b, which moves the product discharge vise 51 in the vertical direction by using the lifting apparatus 50, and moves the product discharge vise 51 on the lifting apparatus 50 in the horizontal direction. The product collection apparatus 60 is driven by a product collection apparatus driving unit 600 provided inside the product collection apparatus 60.

A feed vise driving unit 110, a body vise driving unit 120, the product discharge vise driving unit 510, a saw blade driving unit 300, and the product collection apparatus driving unit 600 are controlled by a control unit 100.

Next, the steps of a control method carried out by the band saw machine according to the second embodiment are explained mainly around a difference from the first embodiment. For the matter of convenience, the same reference numerals as those in the first embodiment are used. The processes A and B are the same as those in the first embodiment.

### (Process C: Retraction Preparation Process of the Band Saw Blade 32)

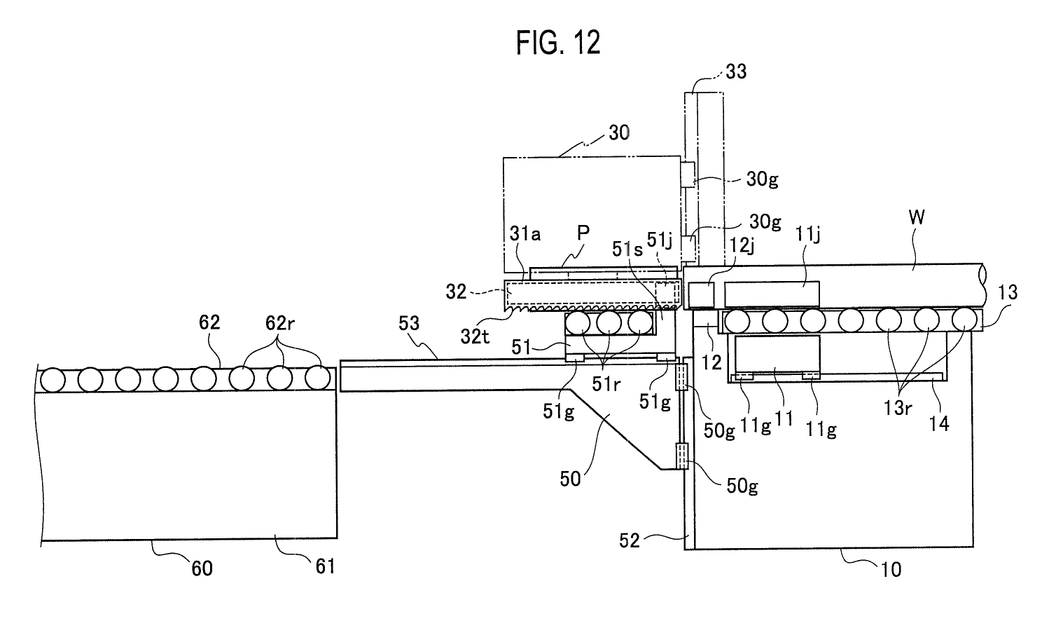

As shown in FIG. 12, after cutting of the work material W is completed, a body vise 12 unclamps the work material W. The feed vise 11 slightly moves the work material W backward, and the product discharge vise 51 slightly moves the product P forward. In other words, the product discharge vise 51 is slightly moved to the downstream side in a state where the lifting apparatus 50 is positioned at an upward end.

### (Process D: Retraction Process of the Band Saw Blade 32 and Discharge Process of the Product P)

Next, the saw blade housing 30 is moved upwardly and the band saw blade 32 is retracted above a pass line. As the lifting apparatus 50 is lowered in the vertical direction, the product discharge vise 51 is lowered while clamping the product P. In the second embodiment, it is possible to start lowering the product discharge vise 51 before or simultaneously with the start of retraction of the band saw blade 32, even when a length of the product P is a maximum length Lmax. In other words, in the second embodiment, it is possible to start discharging the product P after preparation of retraction of the band saw blade 32 is completed, regardless of the length L of the product P and the position of the band saw blade 32.

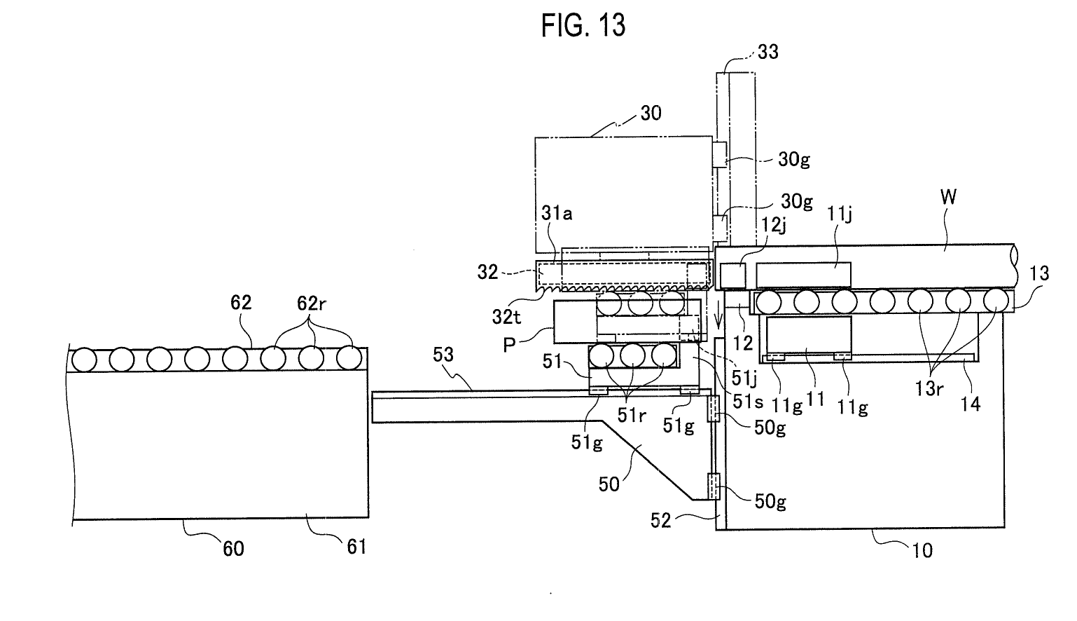

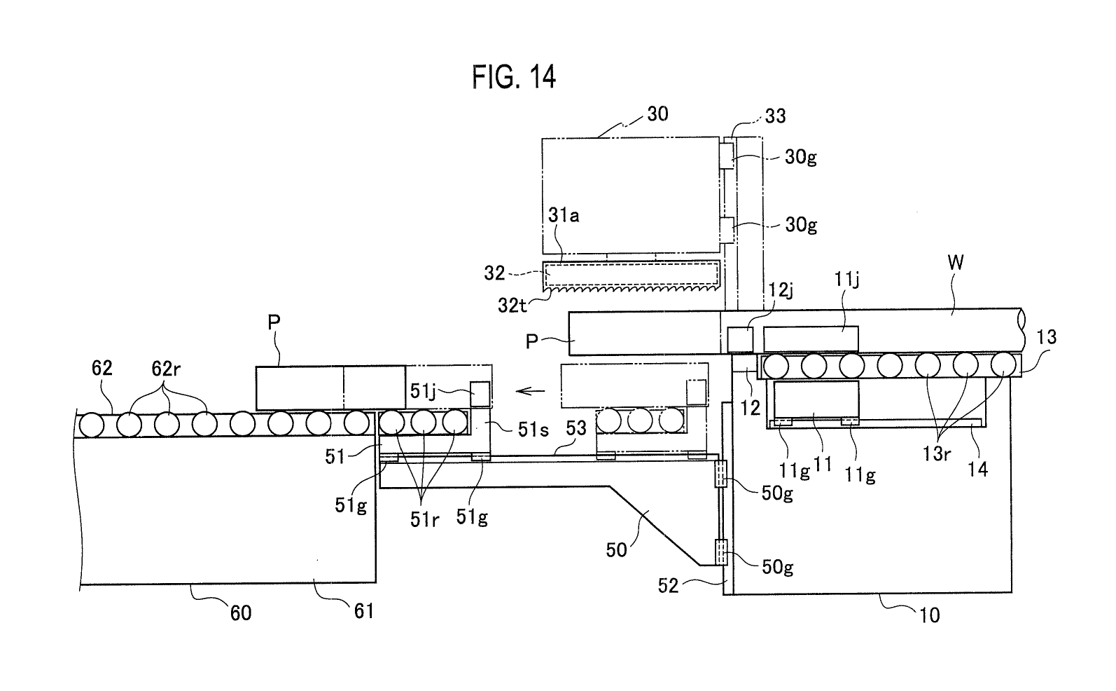

When the product discharge vise 51 is lowered to the downward end as shown in FIG. 13, the product discharge vise 51 is moved in the horizontal direction to an end part of the lifting apparatus 50 on the downstream side as shown in FIG. 14.

### (Process E: Collection Process of the Product P)

When the product discharge vise 51 is moved to the end part, the product discharge vise 51 unclamps the product P. The product collection apparatus 60 conveys and collects the product P by using the product collection conveyor 62.

Process F is the same as that in the first embodiment.

### (Process G: Returning Process of the Product Discharge Vise 51)

After the product P is conveyed by the product collection conveyor 62, the product discharge vise 51 is moved in the horizontal direction to an end part of the lifting apparatus 50 on an upstream side as shown in FIG. 15, and the lifting apparatus 50 is then moved up in the vertical direction to an upward end. The lifting apparatus 50 may be moved up while moving the product discharge vise 51 in the horizontal direction. A support stand 51s of the product discharge vise 51 abuts on the work material W from underneath, and supports the work material W. Then, the product discharge vise 51 clamps the work material W by using the product discharge vise jaws 51j. Thus, the product discharge vise 51 returns to the state shown in FIG. 10.

Process H is the same as that of the first embodiment. FIG. 15 shows a state where the product discharge vise 51 is returned in the process G, which is the returning process of the product discharge vise 51, and the work material W is being cut by the band saw blade 32. It is possible to start the process H, which is the cutting process of the work material W, before the process G, which is the returning process of the product discharge vise 51, is completed. After cutting of the work material W is completed, the processes C to H are repeated, thereby manufacturing the product P sequentially.

In the second embodiment, it is possible to substantially eliminate a loss of tact time, similarly to the first embodiment. In the second embodiment, the product discharge vise 51 that clamps the product P is able to start lowering immediately after cutting is completed. The product discharge vise 51 is able to start lowering at time t2 in FIG. 9 regardless of the length L of the product P.

### Third Embodiment

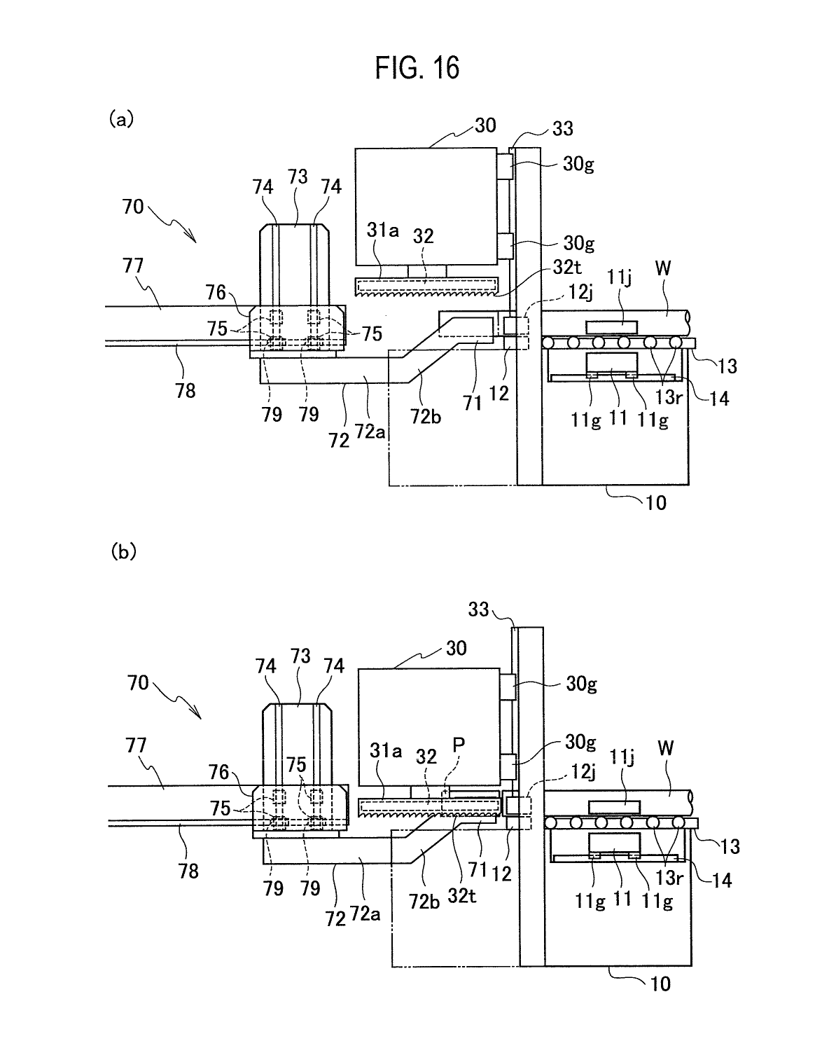

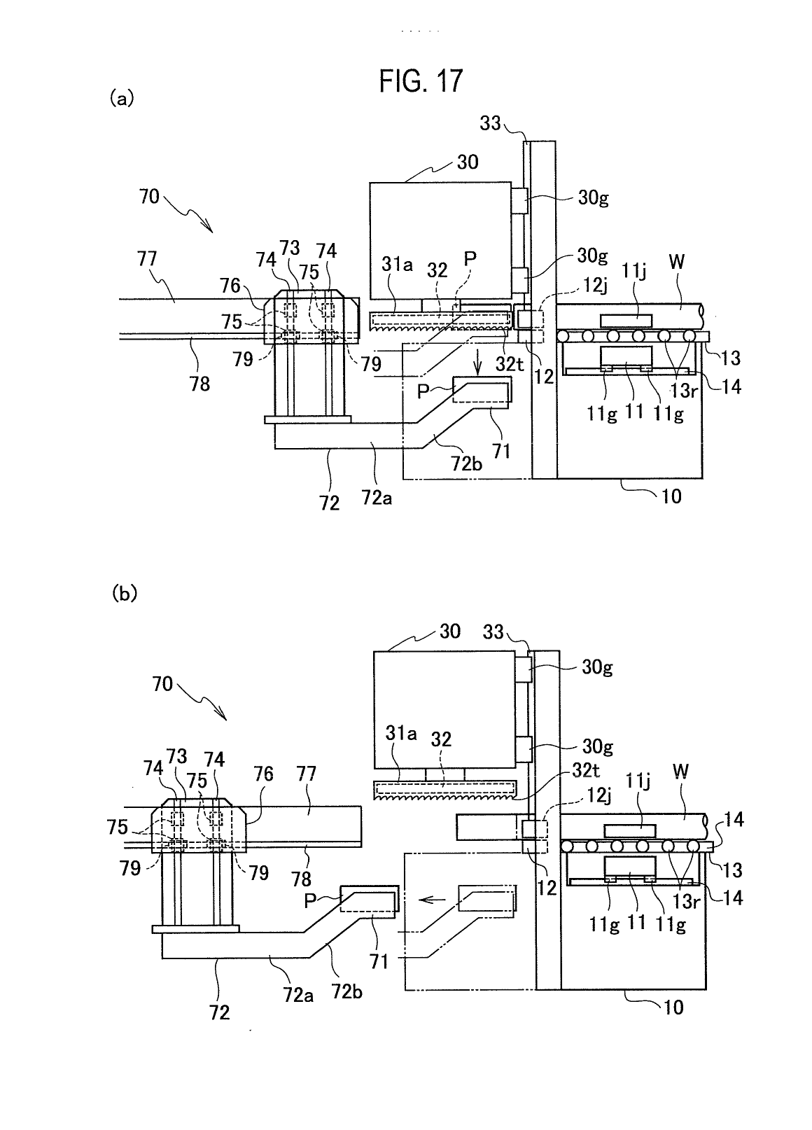

A third embodiment is explained by using FIG. 16 and FIG. 17. In FIG. 16 and FIG. 17 the same reference numerals are used for parts that are substantially the same as those in the second embodiment explained in FIG. 10 to FIG. 15, and explanation thereof is omitted as necessary.

(a) of FIG. 16 shows a state before a work material W is cut according to the third embodiment, and (b) of FIG. 16 shows a state after cutting is completed. A product discharge apparatus 70 includes a product discharge arm 72, a guide plate 73 in a vertical direction, a guide plate 76 in a horizontal direction, and a guide arm 77. The product discharge arm 72 has a horizontal part 72a extending in the horizontal direction, and an inclined part 72b extending from the horizontal part 72a in an obliquely upward direction. A product discharge vise 71 is provided in a distal end of the inclined part 72b. In (a) of FIG. 16, the product discharge vise 71 clamps a work material W that is positioned.

The guide plate 73 has a rail 74, the rail 74 is engaged with two pairs of guides 75 located in line in the vertical direction. The product discharge arm 72 is attached to a lower end part of the guide plate 73. As the rail 74 is moved by the guides 75 in the vertical direction, the product discharge arm 72 and the guide plate 73 move downwardly to be lower than the positions shown in (a) and (b) of FIG. 16. In other words, the product discharge apparatus 70 has a vertically moving mechanism which allows the product discharge arm 72 to move in the vertical direction.

When cutting of the work material W is completed as shown in (b) of FIG. 16, the product discharge arm 72 is lowered while clamping the product P by using the product discharge vise 71 as shown in (a) of FIG. 17. The guide arm 77 has a rail 78, and the rail 78 is arranged in line in the horizontal direction and engaged with guides 79. The guides 79 are attached to the guide plate 76. As the guides 79 move along the rail 78, the product discharge arm 72 and the guide plate 73 move in the horizontal direction. In other words, the product discharge apparatus 70 has a horizontally moving mechanism that allows the product discharge arm 72 to move in the horizontal direction. After the product discharge arm 72 is lowered, the product discharge arm 72 is moved to a downstream side as shown in (b) of FIG. 17.

After the product discharge arm 72 is moved to the downstream side, the product discharge vise 71 unclamps the product P. Then, the product P is further conveyed and collected by a non-illustrated product collection conveyor, or collected in a product collection box and so on. Thereafter, the product discharge arm 72 is moved to the upstream side and moved upwardly so that the product discharge vise 71 is returned to a pass line. Then, similarly to (a) of FIG. 16, the product discharge vise 71 clamps the work material W that is positioned, and repeats the operations shown in (b) of FIG. 16, and (a) and (b) of FIG. 17. In the third embodiment, it is possible to substantially eliminate a loss of tact time.

According to the first to third embodiments described so far, since the band saw blade 32 has zero twisting, it is possible to reduce rupture of the body significantly, thereby extending life of the band saw blade. Despite the zero twisting, there is almost no loss of tact time. Therefore, the band saw machine according to the first to third embodiments has performance that is equal or higher than that of a commonly used band saw machine in which the band saw blade is twisted.

The present invention is not limited to the first to third embodiments explained so far, and various changes may be made without departing from the essence of the present invention.

### INDUSTRIAL APPLICABILITY

The present invention is applicable to a band saw machine for cutting a work material by using a band saw blade.

1. A band saw machine comprising:
a feed vise configured to position a work material on a pass line, the work material being carried in from an upstream side to a downstream side:
a band saw blade, which is wound around a pair of wheels and rotates and travels without being twisted, configured to cut the work material, which is positioned by the feed vice, into a length smaller than a diameter of the wheels, by lowering from above the pass line; and
a product discharge vise that has a vise jaw for clamping the work material, configured to, clamp the work material on a downstream side of a cutting position of the work material before the work material is completely cut by the band saw blade, continue clamping the work material after the cutting, be lowered while clamping a product obtained by cutting the work material, and discharge the product below the pass line.

2. The band saw machine according to claim 1, further comprising a product discharge frame having a slope that slopes down from the upstream side to the downstream side, wherein
the product discharge vise clamping the product is configured to be discharged along the slope.

3. The band saw machine according to claim 1, further comprising:
a vertically moving mechanism configured to lower the product discharge vise clamping the product in a vertical direction; and
a horizontally moving mechanism configured to move the product discharge vise, which is lowered by the vertically moving mechanism, in a horizontal direction to the downstream side.

4. The band saw machine according to claim 1, wherein the product discharge vise includes a support stand that supports the work material from underneath.

5. The band saw machine according to claim 1, wherein the band saw machine is configured so that an upper end part of the vise jaw does not interfere with the band saw blade when the product discharge vise is discharged in a state where the band saw blade is positioned at a downward end where cutting of the work material by the band saw blade is completed.

6. The band saw machine according to claim 1, wherein the product discharge vise clamping the product is configured to be lowered at a timing when the upper end part of the product does not interfere with the band saw blade when the band saw blade is moved up and retracted from the pass line from a state where the band saw blade is positioned at the downward end at which cutting of the work material by the band saw blade is completed.

7. The band saw machine according to claim 1, further comprising a product collection apparatus configured to collect the product discharged by the product discharge vise.

8. A control method of a band saw machine, comprising:
positioning a work material on a pass line by a feed vise, the work material being carried in from an upstream side to a downstream side;
cutting the work material by lowering a band saw blade from above the pass line, which is wound around a pair of wheels and rotates and travels without being twisted, into a length smaller than a diameter of the wheels, the work material being positioned in the positioning;
clamping the work material on a downstream side of a cutting position by a product discharge vise that clamps the work material, before cutting of the work material is completed; and
discharging a product, which is obtained by cutting the work material in the cutting, below the pass line, while the product discharge vise clamps the product.

9. The control method of a band saw machine according to claim 8, wherein, in the discharge, the product discharge vise clamping the product is discharged along a slope that slopes down from the upstream side to the downstream side.

10. The control method of a band saw machine according to claim 8, wherein the discharge includes:
lowering the product discharge vise clamping the product in a vertical direction; and
moving the product discharge vise, which is lowered in the vertical moving step, in a horizontal direction to the downstream side.

11. (canceled)

12. (canceled)

13. The control method of a band saw machine according claim 8, further comprising retraction step of retracting the band saw blade above the pass line after cutting of the work material is completed, wherein,
in the discharge, the product discharge vise clamping the product is lowered at a timing when an upper end part of the product does not interfere with the band saw blade when retracting the band saw blade in the retraction.

14. The control method of a band saw machine according to claim 8, further comprising moving the work material to the upstream side by the feed vise prior to the retraction, and moving the product to the downstream side by the product discharge vise.

15. The control method of a band saw machine according to claim 8, further comprising collecting the product discharged in the discharge step.

16. The control method of a band saw machine according to claim 15, wherein
the positioning, the cutting, the clamping, the discharge, and the product collection are sequentially repeated, and
the control method further comprises returning the product discharge vise, after the product is collected in the product collection, to a position for clamping the work material, which is positioned subsequently, before cutting of the work material in a subsequent cutting is completed, in order that the product discharge vise clamps the work material in a following clamping.

17. The control method of a band saw machine according to claim 16, wherein, in the returning, a support stand included in the product discharge vise supports the work material from underneath.
